(19) United States
(12) Patent Application Publication
(10) Pub. No.: US 2023/0099678 A1
(43) Pub. Date: Mar. 30, 2023

(54) TRAVELING LANE RECOGNITION APPARATUS AND TRAVELING LANE RECOGNITION METHOD

(71) Applicant: Mitsubishi Electric Corporation, Tokyo (JP)

(72) Inventors: Yuko OMAGARI, Tokyo (JP); Masaya ENDO, Tokyo (JP); Junya HATTORI, Tokyo (JP)

(73) Assignee: Mitsubishi Electric Corporation, Tokyo (JP)

(21) Appl. No.: 17/878,532

(22) Filed: Aug. 1, 2022

(30) Foreign Application Priority Data
Sep. 29, 2021 (JP) 2021-158684

(51) Int. Cl. B60W 60/00

(52) U.S. Cl. CPC B60W 60/001; B60W 2552/53; B60W 2556/40; B60W 2552/30; B60W 30/12

(57) ABSTRACT

To provide a traveling lane recognition apparatus and a traveling lane recognition method which can determine the reliability of the detected lane marking information in order to deal with the case where, even though the detecting state of the periphery monitoring apparatus is good, the reliability of the detected lane marking information is bad, and can set appropriately the lane marking information used for autonomous driving. A traveling lane recognition apparatus acquires detection lane marking information based on detection information of a periphery monitoring apparatus; acquires map lane marking information from map data; determines a reliability of the detection lane marking information based on variation of the detection lane marking information; and selects from the detection lane marking information and the map lane marking information based on the reliability, and calculates lane marking information for autonomous driving.

### INCORPORATION BY REFERENCE

The disclosure of Japanese Patent Application No. 2021-158684 filed on Sep. 29, 2021 including its specification, claims and drawings, is incorporated herein by reference in its entirety.

### BACKGROUND

The present disclosure is related with a traveling lane recognition apparatus and a traveling lane recognition method.

Previously, the vehicle control apparatus which sets the travel path where the vehicle travels, and performs steering control of the vehicle so that the vehicle follow the set travel path is known. For example, in the vehicle control apparatus proposed in JP 2017-047798 A, reliability is given to the travel path calculated by the front monitoring camera or the GNSS (Global Navigation Satellite System) sensor, the adoption ratio of the travel path of each sensor is changed according to reliability, and the integrated travel path is calculated. Accordingly, the vehicle is made to follow the optimal path.

### SUMMARY

In this kind of the vehicle control apparatus, the adoption ratio of the travel path of each sensor is changed using the reliability of the detection value of sensor itself, such as the reliability determined from the detecting state of the front monitoring camera. However, for example, when the front monitoring camera detects the double white lines, the inside white line is detected at a certain time, and the outside white line is detected at the next time. Accordingly, variation of the detected lane marking shape may become large. In this case, even though the reliability of the detection value of sensor is high, since variation of the detected lane marking shape is large, there is a problem that it is difficult to generate the stable travel path.

Then, the purpose of the present disclosure is to provide a traveling lane recognition apparatus and a traveling lane recognition method which can determine the reliability of the detected lane marking information in order to deal with the case where, even though the detecting state of the periphery monitoring apparatus is good, the reliability of the detected lane marking information is bad, and can set appropriately the lane marking information used for autonomous driving.

The traveling lane recognition apparatus according to the present disclosure, including:

a detection lane marking acquisition unit that acquires detection lane marking information which is information on position and shape of a lane marking of a traveling lane of an own vehicle on a basis of a position of the own vehicle, based on detection information of a periphery monitoring apparatus which monitors a periphery of the own vehicle;

a map lane marking acquisition unit that acquires road information where the own vehicle is traveling, from map data, and acquires map lane marking information which is information on position and shape of the lane marking of the traveling lane of the own vehicle on the basis of the position of the own vehicle, based on the acquired road information;

a reliability determination unit that determines a reliability of the detection lane marking information, based on variation of the detection lane marking information; and

a driving lane marking calculation unit that selects lane marking information used for autonomous driving from the detection lane marking information and the map lane marking information, based on the reliability of the detection lane marking information, and calculates lane marking information for autonomous driving, based on the selected lane marking information.

The traveling lane recognition method according to the present disclosure, including:

a detection lane marking acquisition step of acquiring detection lane marking information which is information on position and shape of a lane marking of a traveling lane of an own vehicle on a basis of a position of the own vehicle, based on detection information of a periphery monitoring apparatus which monitors a periphery of the own vehicle;

a map lane marking acquisition step of acquiring road information where the own vehicle is traveling, from map data, and acquiring map lane marking information which is information on position and shape of the lane marking of the traveling lane of the own vehicle on the basis of the position of the own vehicle, based on the acquired road information;

a reliability determination step of determining a reliability of the detection lane marking information, based on variation of the detection lane marking information; and

a driving lane marking calculation step of selecting lane marking information used for autonomous driving from the detection lane marking information and the map lane marking information, based on the reliability of the detection lane marking information, and calculating lane marking information for autonomous driving, based on the selected lane marking information.

When the own vehicle is traveling the double white lines section, even if the detecting state of the periphery monitoring apparatus is good, if the detection lane marking information is varied due to variation of the affecting degree of the inside white line and the affecting degree of the outside white line, the lane marking information for autonomous driving which is set based on the detection lane marking information is varied, and it may give an adverse influence on the autonomous driving. According to the traveling lane recognition apparatus and the traveling lane recognition method of the present disclosure, based on the variation of the detection lane marking information, the reliability of the detection lane marking information can be determined appropriately. Then, based on the reliability of the detection lane marking information, the lane marking information used for autonomous driving is appropriately selected from the detection lane marking information and the map lane marking information, and the lane marking information for autonomous driving can be calculated.

### BRIEF DESCRIPTION OF THE DRAWINGS

FIG. 1 is a schematic block diagram of the traveling lane recognition apparatus according to Embodiment 1;

FIG. 2 is a schematic hardware configuration figure of the traveling lane recognition apparatus according to Embodiment 1;

FIG. 3 is another example of schematic hardware configuration diagram of the traveling lane recognition apparatus according to Embodiment 1;

FIG. 4 is a flowchart for explaining schematic processing of the traveling lane recognition apparatus according to Embodiment 1;

FIG. 5 is a figure for explaining the own vehicle coordinate system according to Embodiment 1;

FIG. 6 is a figure for explaining conversion of the past detection lane marking information according to Embodiment 1;

FIG. 7 is a figure for explaining setting of the determination value of frequency according to Embodiment 1;

FIG. 8 is a flowchart for explaining processing of the driving lane marking calculation unit according to Embodiment 3; and

FIG. 9 is a flowchart for explaining processing of the reliability determination unit according to Embodiment 4.

### DETAILED DESCRIPTION OF THE EMBODIMENTS

### 1. Embodiment 1

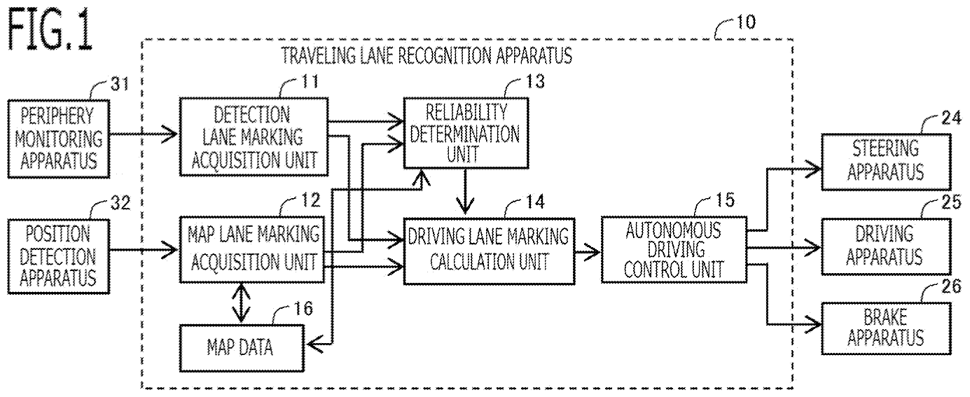

A traveling lane recognition apparatus and a traveling lane recognition method according to Embodiment 1 will be explained with reference to drawings. FIG. 1 is a schematic block diagram of the traveling lane recognition apparatus 10. In the present embodiment, although the traveling lane recognition apparatus 10 is embedded in an autonomous driving apparatus which performs autonomous driving of an own vehicle, a part or all of the traveling lane recognition apparatus 10 may be formed separately from the autonomous driving apparatus.

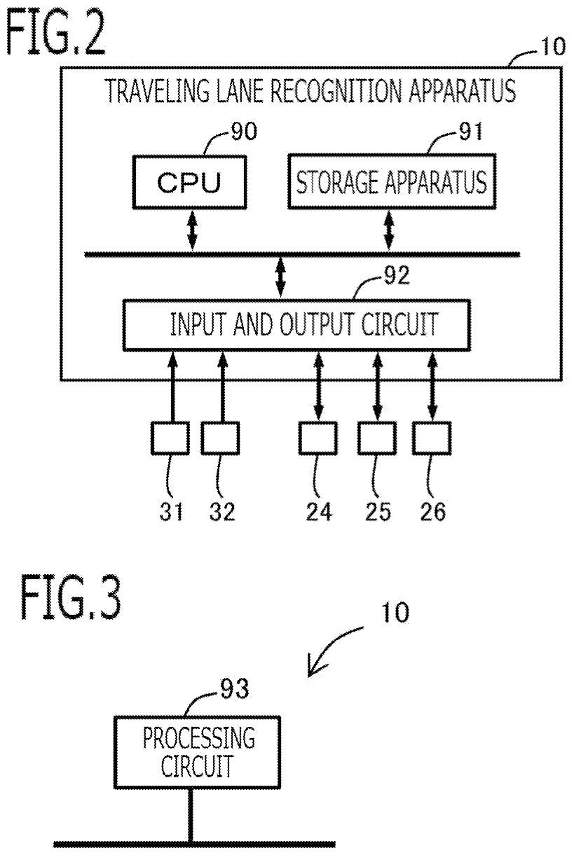

The traveling lane recognition apparatus 10 is provided with processing units such as a detection lane marking acquisition unit 11, a map lane marking acquisition unit 12, a reliability determination unit 13, a driving lane marking calculation unit 14, and an autonomous driving control unit 15. Each processing of the traveling lane recognition apparatus 10 is realized by processing circuits provided in the traveling lane recognition apparatus 10. As shown in FIG. 2, specifically, the traveling lane recognition apparatus 10 is provided with an arithmetic processor 90 such as CPU (Central Processing Unit), a storage apparatus 91, an input and output circuit 92 which outputs and inputs external signals to the arithmetic 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), AI (Artificial Intelligence) chip, various kinds of logical circuits, various kinds of signal processing circuits, and the like may be provided. As the arithmetic processor 90, a plurality of the same type ones or the different type ones may be provided, and each processing may be shared and executed. As the storage apparatus 91, there are provided a RAM (Random Access Memory) which can read data and write data from the arithmetic processor 90, a ROM (Read Only Memory) which can read data from the arithmetic processor 90, and the like. As the storage apparatus 91, various kinds of storage apparatus, such as a flash memory, EEPROM (Electrically Erasable Programmable Read Only Memory), a hard disk, and a DVD apparatus may be used.

The input and output circuit 92 is provided with a communication device, an A/D converter, an input/output port, a driving circuit, and the like. The input and output circuit 92 is connected to a periphery monitoring apparatus 31, a position detection apparatus 32, a steering apparatus 24, a driving apparatus 25, a brake apparatus 26, and the like, and communicates with these apparatuses.

Then, the arithmetic processor 90 runs software items (programs) stored in the storage apparatus 91 such as a ROM and collaborates with other hardware devices in the traveling lane recognition apparatus 10, such as the storage apparatus 91, and the input and output circuit 92, so that the respective functions of the 11 to 15 included in the traveling lane recognition apparatus 10 are realized. Setting data items such as a determination value to be utilized in the processing units 11 to 15 are stored, as part of software items (programs), in the storage apparatus 91 such as a ROM. Each function of the traveling lane recognition apparatus 10 will be explained in detail below.

Alternatively, as shown in FIG. 3, the traveling lane recognition apparatus 10 may be provided with a dedicated hardware 93 as the processing circuit, for example, a single circuit, a combined circuit, a programmed processor, a parallel programmed processor, ASIC, FPGA, GPU, AI chip, or a circuit which combined these.

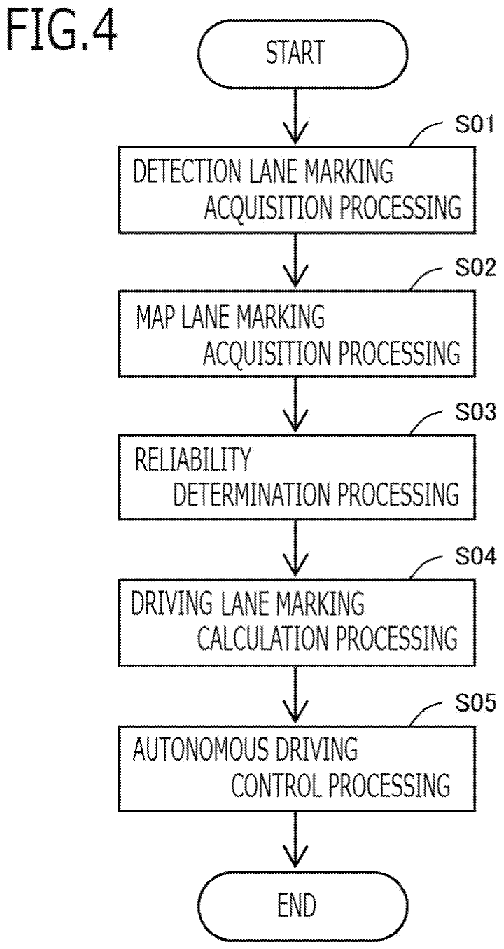

FIG. 4 is a schematic flowchart for explaining the procedure (the traveling lane recognition method) of processing of the traveling lane recognition apparatus 10 according to the present embodiment. The processing of the flowchart in FIG. 4 is recurrently executed every predetermined calculation period by the arithmetic processor 90 by executing software (a program) stored in the storage apparatus 91. The calculation period is set to 0.01 seconds, for example.

### 1-1. Detection Lane Marking Acquisition Unit 11

In the step S01 of FIG. 4, the detection lane marking acquisition unit 11 executes a detection lane marking acquisition processing (a detection lane marking acquisition step) that acquires detection lane marking information which is information on position and shape of a lane marking of a traveling lane of an own vehicle on a basis of a position of the own vehicle, based on information of the periphery monitoring apparatus 31 which monitors a periphery of the own vehicle.

The periphery monitoring apparatus 31 is apparatus which monitor the periphery of the own vehicle, such as a camera and a radar. As the radar, a millimeter wave radar, a laser radar, an ultrasonic radar, and the like are used. The periphery monitoring apparatus 31 includes a camera, a radar, and the like which monitor the front of the own vehicle. Various kinds of well-known image processing is performed to a picture imaged by the camera, and a lane marking of lane is recognized. Although the lane marking is mainly a white line, it is not limited to the white line. A roadside object, such as a guardrail, a pole, a road shoulder, and a wall, may be recognized as the lane marking. The periphery monitoring apparatus 31 includes a laser radar, such as LiDAR (Light Detection and Ranging), which monitors the front of the own vehicle. The white line is recognized from the points that the reflection luminance of the laser radar is high. The roadside object may be recognized by detection of the object position by the laser radar, and the roadside object may be recognized as the lane marking.

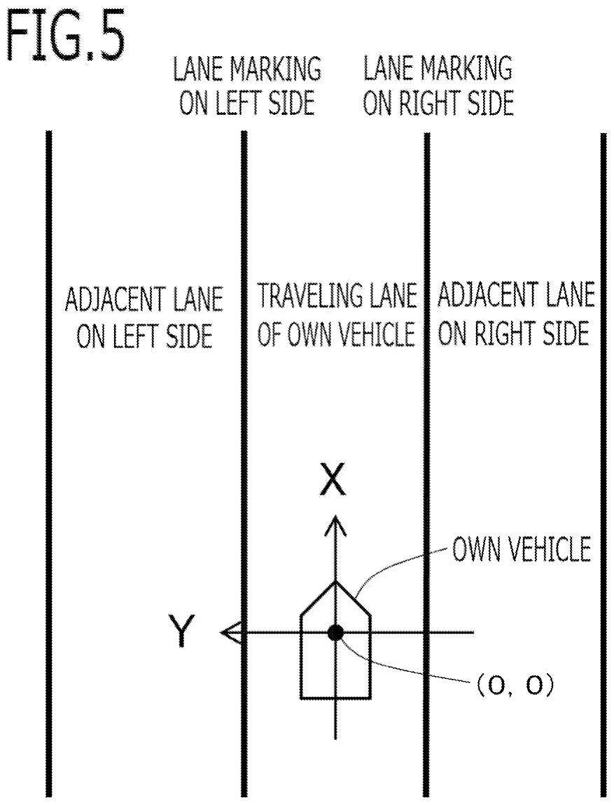

The detection lane marking acquisition unit 11 acquires detection lane marking information which is information on the position and shape of each recognized lane marking in an own vehicle coordinate system. As shown in FIG. 5, the own vehicle coordinate system is a coordinate system which sets the front direction and the lateral direction of the own vehicle as two coordinate axes X and Y. The origin of the own vehicle coordinate system is set at a vicinity of a center of the own vehicle, such as a neutral steer point.

The detection lane marking acquisition unit 11 acquires the detection lane marking information of the lane marking on the left side and the lane marking on the right side of the traveling lane of the own vehicle. The detection lane marking acquisition unit 11 may acquire the detection lane marking information of the adjacent lanes adjacent to the traveling lane of the own vehicle.

In the present embodiment, the detection lane marking acquisition unit 11 acquires at least a curvature of lane marking K2det, as the detection lane marking information. In the present embodiment, the detection lane marking acquisition unit 11 acquires, as the detection lane marking information, a lane marking distance K0det which is a distance in the lateral direction of the lane marking with respect to the own vehicle, a lane marking angle K1det which is an inclination of a part of the lane marking located in the lateral direction of the own vehicle with respect to the traveling direction of the own vehicle, a curvature of lane marking K2det, and a curvature change rate of lane marking K3det. The position of each lane marking in the own vehicle coordinate system can be calculated by the next equation using these parameters K0det to K3det of the detection lane marking information. That is to say, each lane marking is approximated by an approximation equation expressed by a third-order polynomial which sets the position Y in the lateral direction and the position X in the front direction of the lane marking in the own vehicle coordinate system as variables. Each order coefficient is acquired as the parameters K0det to K3det indicating the detection lane marking information. The curvature change rate of lane marking K3det may not be acquired, and it may be approximated by a second-order polynomial which does not have the third-order term of the curvature change rate K3det.

Y=K0 det+K1 det×X+½×K2det×X²+⅙×K3det×X³ (1)

The detection lane marking acquisition unit 11 performs an approximate calculation, based on the detection information of the periphery monitoring apparatus 31, and calculates each parameter K0det to K3det of the detection lane marking information of each lane marking. The detection lane marking acquisition unit 11 may acquire each parameter K0det to K3det of the detection lane marking information of each lane marking calculated by an external apparatus.

The detection lane marking acquisition unit 11 stores the past detection lane marking information of each lane marking acquired at each time point, to the rewritable storage apparatus 91 such as RAM, during a prescribed period. In the present embodiment, the past curvature of lane marking K2det_old and the past curvature change rate of lane marking K3det_old are stored as the past detection lane marking information at least.

### <Conversion of Past Detection Lane Marking Information>

The detection lane marking acquisition unit 11 converts the detection lane marking information acquired in the past into detection lane marking information on the basis of the current position of the own vehicle (referred to as past detection lane marking information after conversion), based on traveling information of the own vehicle.

The detection lane marking acquisition unit 11 acquires traveling information of the own vehicle, based on the detection information of the position detection apparatus 32. As the position detection apparatus 32, a speed sensor, a yaw rate sensor, and the like are provided. The speed sensor is a sensor which detects a travelling speed (vehicle speed) of the own vehicle, and detects a rotational speed of the wheels, and the like. An acceleration sensor may be provided, and the travelling speed of vehicle may be calculated based on acceleration. The yaw rate sensor is a sensor which detects yaw rate information relevant to a yaw rate of the own vehicle. As the yaw rate information, a yaw rate, a yaw angle, a yaw moment, or the like is detected. If the yaw angle is time-differentiated, the yaw rate can be calculated. If prescribed calculation is performed using the yaw moment, the yaw rate can be calculated.

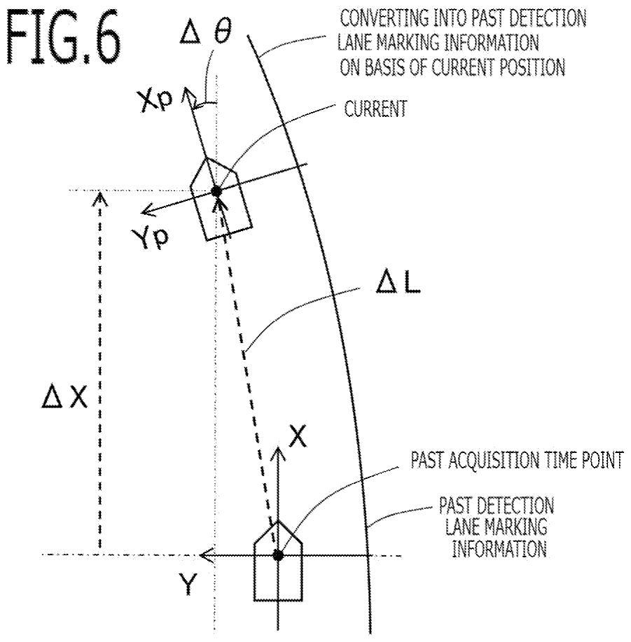

As shown in FIG. 6, the detection lane marking acquisition unit 11 acquires a traveling distance ΔL and a change amount of yaw angle A of the current own vehicle on the basis of the position of the own vehicle (the own vehicle coordinate system) at the acquisition time point of the detection lane marking information, as the traveling information of the own vehicle.

The detection lane marking acquisition unit 11 calculates the traveling distance ΔL of the own vehicle and the change amount of yaw angle A of the own vehicle from the acquisition time point of the detection lane marking information to the current time point, based on the detection values of the vehicle speed and the yaw rate of the own vehicle. For example, the detection lane marking acquisition unit 11 calculates the change amount of yaw angle A by integrating the yaw rate from the past time point to the current time point, and calculates the traveling distance ΔL by integrating the vehicle speed from the past time point to the current time point.

The detection lane marking acquisition unit 11 converts the past detection lane marking information acquired at each time point into past detection lane marking information on the basis of the current position of the own vehicle (hereinafter, referred to as past detection lane marking information after conversion), based on the traveling distance ΔL and the change amount of yaw angle A of the own vehicle from the acquisition time point of the detection lane marking information to the current time point.

The detection lane marking acquisition unit 11 converts about each parameter of the past detection lane marking information after conversion used in the reliability determination unit 13 described below. In the present embodiment, the past curvature K2det_old and the past curvature change rate K3det_old are used in the reliability determination unit 13. Since the past curvature change rate K3det_old does not change before and after conversion, the past curvature K2det_old is converted.

Using the next equation, the detection lane marking acquisition unit 11 calculates a traveling distance ΔX in the front direction in the own vehicle coordinate system at the time of acquisition of the lane marking information, based on the traveling distance ΔL and the change amount of yaw angle A of the own vehicle.

ΔX=ΔL×cos Δθ≅ΔL×(1−½Δθ²) (2)

Using the next equation, the detection lane marking acquisition unit 11 converts the past curvature K2det_old into past curvature K2det_oldcnv on the basis of the current position of the own vehicle (hereinafter, referred to as past curvature after conversion K2det_oldcnv), based on the traveling distance ΔX in the front direction of the own vehicle, the past curvature K2det_old, and the past curvature change rate K3det_old.

K2det_oldcnv=K2det_old+K3det_old×ΔX (3)

According to this configuration, for example, when the curvature change rate is not 0 and the curvature changes in the vicinity of entrance and exit of curve, the calculation accuracy of the past curvature on the basis of the current position of the own vehicle can be improved.

As mentioned above, if the lane marking is approximated by the second-order polynomial, since the third-order term of the curvature change rate K3det is deleted, and the second term of the right side of the equation (3) is deleted, the past curvature K2det_old is set as the past curvature after conversion K2det_oldcvn as it is.

Since the past curvature change rate K3det_old is not changed before and after conversion in the third-order polynomial, as shown in the next equation, the past curvature change rate K3det_old is set as the past curvature after conversion change rate K3det_oldcvn as it is.

K3det_oldcnv=K3det_old (4)

In the reliability determination unit 13 described below, if the past lane marking distance K0det_old and the past lane marking angle K1det_old are used, these past parameters also may be converted into past parameters on the basis of the current position of the own vehicle using the well-known calculation equation, based on the traveling distance ΔL and the change amount of yaw angle A of the own vehicle.

### 1-2. Map Lane Marking Acquisition Unit 12

In the step S02 of FIG. 4, the map lane marking acquisition unit 12 executes a map lane marking acquisition processing (a map lane marking acquisition step) that acquires road information where the own vehicle is traveling, from map data 16; and acquires map lane marking information which is information on position and shape of the lane marking of the traveling lane of the own vehicle on the basis of the position of the own vehicle, based on the acquired road information.

The map lane marking acquisition unit 12 acquires the road information from the current position of the own vehicle to a front acquisition distance, from the map data 16. As the travelling speed of the own vehicle becomes fast, the acquisition distance may be lengthened. The acquired road information includes information on position and shape of each lane. The map lane marking acquisition unit 12 acquires the map lane marking information of the traveling lane of the own vehicle on the basis of the position of the own vehicle, based on the acquired road information of the prescribed section.

As the position detection apparatus 32, a GPS antenna which receives signal outputted from satellites such as GNSS (Global Navigation Satellite System), and the like is provided. The map lane marking acquisition unit 12 acquires the current position of the own vehicle, based on detection information of the GPS antenna. The map lane marking acquisition unit 12 acquires a traveling direction of the own vehicle, based on the current position of the own vehicle, the detection information of the acceleration sensor, and the like.

The map lane marking acquisition unit 12 may acquire road information from the map data 16 stored in the storage apparatus in the own vehicle of traveling lane recognition apparatus 10 and the like, or may acquire road information from the map data 16 stored in the server outside the own vehicle via the communication line. In this example, the map data 16 stored in the storage apparatus of the traveling lane recognition apparatus 10 is used.

In the present embodiment, the map lane marking acquisition unit 12 acquires at least the curvature K2map as the map lane marking information. In the present embodiment, the map lane marking acquisition unit 12 acquires, as the map lane marking information, a lane marking distance K0map which is a distance in the lateral direction of the lane marking with respect to the own vehicle, a lane marking angle K1map which is an inclination of a part of the lane marking located in the lateral direction of the own vehicle with respect to the traveling direction of the own vehicle, a curvature K2map, and a curvature change rate K3map. Using these parameters K0map to K3map of the map lane marking information, the position of each lane marking in the own vehicle coordinate system can be calculated by the next equation. That is to say, each lane marking is approximated by an approximation equation expressed by a third-order polynomial which sets the position Y in the lateral direction and the position X in the front direction of the lane marking in the own vehicle coordinate system as variables. Each order coefficient is acquired as the parameter K0map to K3map indicating the map lane marking information. The curvature change rate K3map may not be acquired, and it may be approximated by a second-order polynomial which does not have the third-order term of the curvature change rate K3map.

Y=K0map+K1map×X+½×K2map×X²+⅙×K3map×X³ (5)

The map lane marking acquisition unit 12 performs an approximate calculation based on the acquired road information of the prescribed section, and calculates each parameter K0map to K3map of the map lane marking information of each lane marking. For example, if a point sequence of the center position of the traveling lane is obtained as the road information, the map lane marking acquisition unit 12 calculates an approximated curve of the center positions of the traveling lane of the own vehicle in the own vehicle coordinate system; sets the coefficient of the first-order term, the coefficient of the second-order term, and the coefficient of the third-order term of the approximated curve of the center positions, as the lane marking angle K1map of the right and left lane markings of the traveling lane of the own vehicle, the curvature K2map of the right and left lane markings, and the curvature change rate K3map of the right and left lane markings, respectively; and sets a distance according to the lane width included in the road information, as the lane marking distance K0map of the right and left lane markings. Alternatively, if point sequences of the positions of the right and left lane markings of the traveling lane are obtained as the road information, the map lane marking acquisition unit 12 calculates approximated curves of the right and left lane markings of the traveling lane of the own vehicle in the own vehicle coordinate system; and sets each order coefficient of each approximated curve, as each parameter K0map to K3map indicating the map lane marking information of the right and left lane markings.

Alternatively, if the acquired road information of the prescribed section includes information of the curvature, the curvature change rate, and the like, the map lane marking acquisition unit 12 may set these as the curvature K2map of the right and left lane markings, the curvature change rate K3map of the right and left lane markings, and the like.

### 1-3. Reliability Determination Unit 13

In the step S03 of FIG. 4, the reliability determination unit 13 executes a reliability determination processing (a reliability determination step) that determines a reliability of the detection lane marking information, based on variation of the detection lane marking information.

According to this configuration, based on the variation of the detection lane marking information, the reliability of the detection lane marking information can be determined appropriately.

### <Determination of Reliability by Time Variation Amount>

In the present embodiment, the reliability determination unit 13 determines that the reliability of the detection lane marking information is low, when an absolute value of time variation amount of the detection lane marking information is greater than or equal to a determination value of time variation amount. The reliability determination unit 13 determines that the reliability of the detection lane marking information is high, when the absolute value of time variation amount of the detection lane marking information is less than the determination value of time variation amount.

When traveling the double white lines section, the detection lane marking information is easily varied due to variation of the affecting degree of the inside white line and the affecting degree of the outside white line with respect to detection of the lane marking. The double white lines are two white lines which adjoin and become parallel with each other. If the detection accuracy of the lane marking is deteriorated due to a blur of the white line, an environmental condition, or the like, the detection lane marking information will be varied easily. Since the own vehicle is traveling the double white lines section, or since the detection accuracy of the lane marking is deteriorated due to the blur of the white line, the environmental condition, or the like, when the absolute value of time variation amount of the detection lane marking information becomes larger than the determination value of time variation amount, it is determined that the reliability of the detection lane marking information is low, and the map lane marking information is used for the lane marking information for autonomous driving in the driving lane marking calculation unit 14 described below, and the accuracy of lane marking information for autonomous driving can be improved. On the other hand, since the own vehicle is traveling the single white line section and the detection accuracy of the lane marking is good, when the absolute value of time variation amount of the detection lane marking information becomes smaller than the determination value of time variation amount, it is determined that the reliability of the detection lane marking information is high, the detection lane marking information is used for the lane marking information for autonomous driving in the driving lane marking calculation unit 14 described below, and the accuracy of the lane marking information for autonomous driving can be improved.

In the present embodiment, the reliability determination unit 13 calculates the time variation amount of the detection lane marking information, based on the current detection lane marking information and the past detection lane marking information after conversion on the basis of the current position of the own vehicle.

According to this configuration, the time variation amount of detection lane marking information can be prevented from increasing due to traveling of the own vehicle, and the calculation accuracy of the time variation amount can be improved.

### <Determination of Reliability by Time Variation Amount of Curvature>

The reliability determination unit 13 determines that the reliability of the detection lane marking information is low, when an absolute value of time variation amount of the curvature of the detection lane marking information is greater than or equal to a determination value of time variation amount of curvature. The reliability determination unit 13 determines that the reliability of the detection lane marking information is high, when the absolute value of time variation amount of the curvature is less than the determination value of time variation amount of curvature. About each of the curvatures of the right and left lane markings of the traveling lane of the own vehicle, the time variation amount of the curvature is calculated and the reliability is determined.

The lane marking distance K0det and the lane marking angle K1det which are detection lane marking information with large influence of a lane marking part close to the own vehicle are hardly varied due to the double white lines or the deterioration of detection accuracy of the lane marking. On the other hand, the curvature K2det which is detection lane marking information with large influence of a lane marking part far from the own vehicle is easily varied due to the double white lines or the deterioration of detection accuracy of the lane marking. Accordingly, the reliability of the detection lane marking information can be determined with good accuracy by the time variation amount of curvature.

For example, the reliability determination unit 13 calculates a deviation between the curvature K2det acquired this time and the past curvature after conversion K2det_oldcnv, as the time variation amount. As the past curvature after conversion K2det_oldcnv for calculation of the time variation amount, the past curvature after conversion K2det_oldcnv acquired before a predetermined period (for example, last time) may be used, or a value obtained by performing an averaging processing or a filter processing to a plurality of the past curvatures after conversion K2det_oldcnv (for example, 5) acquired in the past may be used. As the averaging processing, a simple average may be used, or a weighted average may be used. As an acquisition time point of a value to which the weight is multiplied becomes new, the weight of the weighted average may be increased. Or, as a position at an acquisition time point of a value to which the weight is multiplied becomes close to the current position, the weight of the weighted average may be increased. As the filter processing, a low pass filter, such as a first order lag filter, is used.

As mentioned above, if the lane marking is approximated by the second-order polynomial, since the past curvature K2det_old does not change before and after conversion, the past curvature K2det_old may be used for calculation of the time variation amount.

### <Determination of Reliability by Time Variation Amount of Curvature Change Rate>

In the present embodiment, the reliability determination unit 13 determines that the reliability of the detection lane marking information is low, when an absolute value of time variation amount of the curvature change rate of the detection lane marking information is greater than or equal to a determination value of time variation amount of change rate. The reliability determination unit 13 determines that the reliability of the detection lane marking information is high, when the absolute value of time variation amount of the curvature change rate is less than the determination value of time variation amount of change rate. About each of the curvature change rates of the right and left lane markings of the traveling lane of the own vehicle, the time variation amount of the curvature change rate is calculated and the reliability is determined.

According to this configuration, similarly to the curvature K2det, the curvature change rate K3det which is detection lane marking information with large influence of a lane marking part far from the own vehicle is easily varied due to the double white lines or the deterioration of detection accuracy of the lane marking. Accordingly, the reliability of the detection lane marking information can be determined with good accuracy by the time variation amount of curvature change rate.

For example, the reliability determination unit 13 calculates an absolute value of a deviation between the curvature change rate K3det acquired this time and the past curvature change rate after conversion K3det_oldcnv (in this example, it may be the past curvature change rate K3det_old), as the time variation amount. For calculation of the time variation amount, the past curvature change rate K3det_old acquired last time may be used, or a value obtained by performing an averaging processing or a filter processing to a plurality of the past curvature change rates after conversion K3det_oldcnv (for example, 5) acquired in the past may be used. As the averaging processing, a simple average may be used, or a weighted average may be used. As an acquisition time point of a value to which the weight is multiplied becomes new, the weight of the weighted average may be increased. Or, as a position at an acquisition time point of a value to which the weight is multiplied becomes close to the current position, the weight of the weighted average may be increased. As the filter processing, a low pass filter, such as a first order lag filter, is used.

### <Overall Determination by Curvature and Curvature Change Rate>

In the present embodiment, about each of the right and left lane markings of the traveling lane of the own vehicle, the reliability determination unit 13 comprehensively determines that the reliability of the detection lane marking information is high, when both of the reliability determined by the time variation amount of curvature and the reliability determined by the time variation amount of curvature change rate are high; and comprehensively determines that the reliability of the detection lane marking information is low, when one or both of the reliability determined by the time variation amount of curvature and the reliability determined by the time variation amount of curvature change rate are low.

According to this configuration, since it is comprehensively determined that the reliability is low when at least one of reliabilities is low, it can be determined on safe side.

If it is configured that either one of the reliability by the time variation amount of curvature and the reliability by the time variation amount of curvature change rate is determined, the determined one reliability may be set as the comprehensive reliability as it is.

### <Determination by Frequency>

In the present embodiment, the reliability determination unit 13 finally determines that the reliability of the detection lane marking information is low, when a frequency at which it was determined that the reliability of the detection lane marking information is low based on the absolute value of time variation amount of one or both of the curvature and the curvature change rate is greater than or equal to a determination value of frequency; and finally determines that the reliability of the detection lane marking information is high, when the frequency at which it was determined that the reliability of the detection lane marking information is low based on the absolute value of time variation amount of one or both of the curvature and the curvature change rate is less than the determination value of frequency.

For example, the reliability determination unit 13 finally determines that the reliability of the detection lane marking information is low, when a count at which it was determined that the reliability of the detection lane marking information is low based on the absolute value of time variation amount of one or both of the curvature and the curvature change rate (hereinafter, referred to as a low reliability determination count) among the past total evaluation count (for example, 10) is greater than or equal to a determination value of count (for example, 3); and finally determines that the reliability of the detection lane marking information is high, when the low reliability determination count among the past total evaluation count is less than the determination value of count. In this case, the determination value of frequency corresponds to a value obtained by dividing the determination value of count by the total evaluation count.

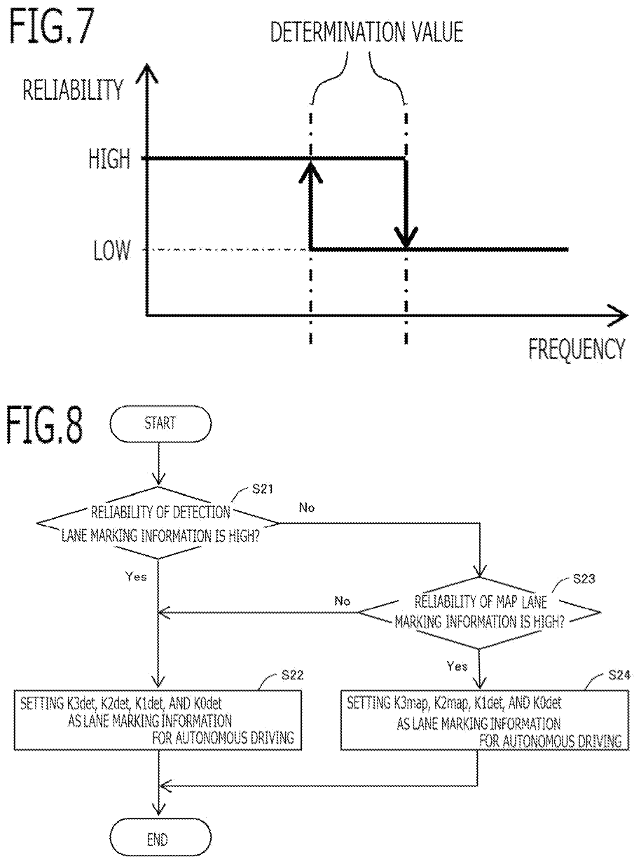

In the present embodiment, as shown in FIG. 7, the reliability determination unit 13 makes the determination value of frequency used when it is currently determined that the reliability of the detection lane marking information is low lower than the determination value of frequency used when it is currently determined that the reliability of the detection lane marking information is high.

In the present embodiment, one or both of the determination value of count and the total evaluation count are changed according to the current reliability. For example, the reliability determination unit 13 makes the determination value of count used when it is currently determined that the reliability of the detection lane marking information is low (for example, 1) lower than the determination value of count used when it is currently determined that the reliability of the detection lane marking information is high (for example, 3). The reliability determination unit 13 makes the total evaluation count used when it is currently determined that the reliability of the detection lane marking information is low (for example, 30) higher than the total evaluation count used when it is currently determined that the reliability of the detection lane marking information is high (for example, 10).

The determination value of frequency used when it is currently determined that the reliability of the detection lane marking information is high may be the same value as the determination value of frequency used when it is currently determined that the reliability of the detection lane marking information is low.

According to this configuration, since the determination value of frequency is made relatively low when it is currently determined that the reliability of the detection lane marking information is low, it becomes hardly transfer to the state where reliability is high from the state where reliability is low. Accordingly, in the driving lane marking calculation unit 14 described below, the variation frequency of the absolute value of time variation amount becomes large, and the lane marking information for autonomous driving was changed into the map lane marking information from the detection lane marking information. After that, after the variation frequency of the absolute value of time variation amount becomes sufficiently small, the lane marking information for autonomous driving is changed into the detection lane marking information from the map lane marking information. Accordingly, for example, it becomes the double white lines section, and the lane marking information for autonomous driving was changed into the map lane marking information from the detection lane marking information. After that, until the double white lines section is ended, the lane marking information for autonomous driving is hardly changed into the detection lane marking information from the map lane marking information. Therefore, the lane marking information for autonomous driving can be stabilized on safe side where accuracy becomes high, and the accuracy of the autonomous driving can be improved.

### 1-4. Driving Lane Marking Calculation Unit 14

In the step S04 of FIG. 4, the driving lane marking calculation unit 14 executes a driving lane marking calculation processing (a driving lane marking calculation step) that selects lane marking information used for autonomous driving from the detection lane marking information and the map lane marking information, based on the reliability of the detection lane marking information; and calculates lane marking information for autonomous driving, based on the selected lane marking information.

According to this configuration, based on the reliability of the detection lane marking information, the lane marking information used for autonomous driving is appropriately selected from the detection lane marking information and the map lane marking information, and the lane marking information for autonomous driving can be calculated.

In the present embodiment, the driving lane marking calculation unit 14 selects the curvature K2det of the detection lane marking information, when it is determined that the reliability of the detection lane marking information is high; selects the curvature K2mp of the map lane marking information, when it is determined that the reliability of the detection lane marking information is low; and calculates the lane marking information for autonomous driving using at least selected curvature.

According to this configuration, when it is determined that the reliability of the detection lane marking information is low due to the double white lines or the deterioration of detection accuracy of the lane marking, since the lane marking information for autonomous driving is calculated using the curvature K2map of the map lane marking information instead of the curvature K2det of the detection lane marking information with low reliability, the accuracy of the lane marking information for autonomous driving can be improved.

And, the driving lane marking calculation unit 14 selects the curvature change rate K3det of the detection lane marking information, when it is determined that the reliability of the detection lane marking information is high; selects the curvature change rate K3map of the map lane marking information, when it is determined that the reliability of the detection lane marking information is low; and calculates the lane marking information for autonomous driving using at least selected curvature change rate.

The driving lane marking calculation unit 14 uses selected the curvature change rate K3det of the detection lane marking information or the curvature change rate K3map of the map lane marking information, selected the curvature K2det of the detection lane marking information or the curvature K2map of the map lane marking information, the lane marking angle K1det of the detection lane marking information, and the lane marking distance K0det of the detection lane marking information, for the lane marking information for autonomous driving.

The calculation of the lane marking information for autonomous driving is performed about each of the right and left lane markings of the traveling lane of the own vehicle.

The lane marking information for autonomous driving of each of the right and left lane markings of the traveling lane of the own vehicle becomes like the next equation using each selected and set parameter K0drv to K3drv, similarly to the detection lane marking information and the map lane marking information.

Y=K0drv+K1drv×X+½×K2drv×X²+⅙×K3drv×X³

K0drv=K0 det

K1drv=K1det

K2drv=K2det or K2map

K3drv=K3det or K3map (6)

As mentioned above, the lane marking distance K0det and the lane marking angle K1det which are detection lane marking information with large influence of a lane marking part close to the own vehicle are hardly varied due to the double white lines or the deterioration of detection accuracy of the lane marking. Therefore, by using the lane marking angle K1det and the lane marking distance K0det of the detection lane marking information for the lane marking information for autonomous driving regardless of high and low of reliability, the lane marking information actually detected by the periphery monitoring apparatus 31 is used for the lane marking part close to the own vehicle, and short-distance autonomous driving can be performed with good accuracy based on the actual relative position between the own vehicle and the lane marking. On the other hand, by using the lane marking information which selected the curvature and the curvature change rate with high reliability for the lane marking part far from the own vehicle, long-distance autonomous driving can be performed with good accuracy.

If the detection lane marking information is approximated by the second-order polynomial, the curvature change rate may not be selected, and the curvature change rate may not be used for the lane marking information for autonomous driving.

### 1-5. Autonomous Driving Control Unit 15

In the step S05 of FIG. 4, the autonomous driving control unit 15 executes an autonomous driving control processing (an autonomous driving control step) that controls a steering angle of wheels, based on the lane marking information for autonomous driving.

As the autonomous driving which controls the steering angle, there are various kinds of controls, such as a lane keeping control and a target track tracking control, and the lane marking information for autonomous driving is used for those control.

For example, when the lane keeping control is performed, the autonomous driving control unit 15 calculates a command value of the steering angle of wheels which makes the own vehicle keep and travel the traveling lane, based on a positional relationship of the own vehicle with respect to the right and left lane markings of the traveling lane calculated by the lane marking information for autonomous driving, and the vehicle speed, and transmits it to the steering apparatus 24.

When the target track tracking control is performed, the autonomous driving control unit 15 sets a target traveling track for performing a traveling of the current traveling lane, a lane change, an obstacle avoidance, and the like, based on the right and left lane markings of the traveling lane calculated by the lane marking information for autonomous driving; and calculates a command value of the steering angle of wheels which makes the own vehicle follow the target traveling track, based on a positional relationship of the own vehicle with respect to the target traveling track, and the vehicle speed, and transmits it to the steering apparatus 24.

The steering apparatus 24 is an electric power steering apparatus, and manipulates the steering angle of wheels by a driving force of an electric motor. The steering apparatus 24 performs driving control of the electric motor so that an actual steering angle follows the command value of the steering angle.

The autonomous driving control unit 15 may control a driving force of wheels, a braking force of wheels, and the like, based on the lane marking information for autonomous driving. A control content is changed according to an autonomous driving level. For example, the autonomous driving control unit 15 sets the target traveling track based on the lane marking information for autonomous driving; and calculates a command value of the steering angle, a command value of the driving force, and a command value of the braking force, which make the own vehicle follow the target traveling track, and transmits these to the steering apparatus 24, the driving apparatus 25, and the brake apparatus 26. The driving apparatus 25 consists of one or both of an engine and a motor, and the like, and the brake apparatus 26 consists of an electric brake and the like.

### 2. Embodiment 2

Next, the traveling lane recognition apparatus 10 and the traveling lane recognition method according to Embodiment 2 will be explained. The explanation for constituent parts the same as those in Embodiment 1 will be omitted. The basic configuration of the traveling lane recognition apparatus 10 and the traveling lane recognition method according to the present embodiment is the same as that of Embodiment 1. Embodiment 2 is different from Embodiment 1 in a part of processing of the reliability determination unit 13.

Similarly to Embodiment 1, the reliability determination unit 13 determines the reliability of the detection lane marking information, based on the variation of detection lane marking information.

Unlike Embodiment 1, the reliability determination unit 13 determines that the reliability of the detection lane marking information is low, when a variation degree of the time series data of the detection lane marking information is greater than or equal to a determination value of variation degree; and determines that the reliability of the detection lane marking information is high, when the variation degree of the time series data of the detection lane marking information is less than the determination value of variation degree. Herein, the time series data are a plurality of data acquired in current and past, and a variation degree of the plurality of data is calculated.

As mentioned above, when the own vehicle is traveling the double white lines section, or when the detection accuracy of the lane marking is deteriorated due to the blur of the white line, the environmental condition, or the like, the detection lane marking information is varied easily. Since the own vehicle is traveling the double white lines section, or since the detection accuracy of the lane marking is deteriorated, when the variation degree of the time series data of the detection lane marking information becomes larger than the determination value of variation degree, it is determined that the reliability of the detection lane marking information is low, and in the driving lane marking calculation unit 14, the map lane marking information can be used for the lane marking information for autonomous driving, and the accuracy of the lane marking information for autonomous driving can be improved. On the other hand, since the own vehicle is traveling the single white line section and the detection accuracy of the lane marking is good, when the variation degree of the time series data of the detection lane marking information is smaller than the determination value of variation degree, it is determined that the reliability of the detection lane marking information is high, and in the driving lane marking calculation unit 14 described below, the detection lane marking information can be used for the lane marking information for autonomous driving, and the accuracy of the lane marking information for autonomous driving can be improved.

The reliability determination unit 13 calculates the variation degree of the time series data of the detection lane marking information, based on the current detection lane marking information and the past detection lane marking information after conversion on the basis of a current position of the own vehicle.

According to this configuration, the variation degree of the time series data of the detection lane marking information can be prevented from increasing due to traveling of the own vehicle, and the calculation accuracy of the time variation amount can be improved.

### <Determination of Reliability by Variation Degree of Time Series Data of Curvature>

The reliability determination unit 13 determines that the reliability of the detection lane marking information is low, when a variation degree of time series data of the curvature of the detection lane marking information is greater than or equal to a determination value of variation degree of curvature; and determines that the reliability of the detection lane marking information is high, when the variation degree of the time series data of the curvature is less than the determination value of variation degree of curvature. About each of the curvatures of the right and left lane markings of the traveling lane of the own vehicle, the variation degree of the time series data of the curvature is calculated, and the reliability is determined.

The lane marking distance K0det and the lane marking angle K1det which are detection lane marking information with large influence of a lane marking part close to the own vehicle are hardly varied due to the double white lines or the deterioration of detection accuracy of the lane marking. On the other hand, the curvature K2det which is detection lane marking information with large influence of a lane marking part far from the own vehicle is easily varied due to the double white lines or the deterioration of detection accuracy of the lane marking. Therefore, by the variation degree of the time series data of the curvature, the reliability of the detection lane marking information can be determined with good accuracy.

For example, the reliability determination unit 13 calculates the variation degree by performing a statistical processing to the curvature K2det acquired this time and a plurality of the past curvatures after conversion K2det_oldcnv acquired from a determination time ago to the last time. As the variation degree, a standard deviation, a variance, or the like is calculated.

As mentioned above, if the lane marking is approximated by the second-order polynomial, since the past curvature K2det_old does not change before and after conversion, the past curvature K2det_old may be used for calculation of the variation degree.

### <Determination of Reliability by Variation Degree of Time Series Data of Curvature Change Rate>

In the present embodiment, the reliability determination unit 13 determines that the reliability of the detection lane marking information is low, when a variation degree of time series data of the curvature change rate of the detection lane marking information is greater than or equal to a determination value of variation degree of change rate; and determines that the reliability of the detection lane marking information is high, when the variation degree of time series data of the curvature change rate is less than the determination value of variation degree of change rate. About each of the curvature change rates of the right and left lane markings of the traveling lane of the own vehicle, the variation degree of time series data of the curvature change rate is calculated, and the reliability is determined.

According to this configuration, similarly to the curvature K2det, the curvature change rate K3det which is detection lane marking information with large influence of a lane marking part far from the own vehicle is easily varied due to the double white lines or the deterioration of detection accuracy of the lane marking. Accordingly, the reliability of the detection lane marking information can be determined with good accuracy by the variation degree of time series data of the curvature change rate.

For example, the reliability determination unit 13 calculates a variation degree by performing a statistical processing to the curvature change rate K3det acquired this time and a plurality of the past curvature change rates after conversion K3det_oldcnv acquired from a determination time ago to the last time (in this example, it may be the past curvature change rate K3det_old). As the variation degree, a standard deviation, a variance, or the like is calculated.

### <Overall Determination by Curvature and Curvature Change Rate>

Similarly to Embodiment 1, about each of the right and left lane markings of the traveling lane of the own vehicle, the reliability determination unit 13 comprehensively determines that the reliability of the detection lane marking information is high, when both of the reliability determined by the variation degree of time series data of the curvature and the reliability determined by the variation degree of the time series data of the curvature change rate are high; and comprehensively determines that the reliability of the detection lane marking information is low, when one or both of the reliability determined by the variation degree of time series data of the curvature and the reliability determined by the variation degree of time series data of the curvature change rate are low.

According to this configuration, since it is comprehensively determined that the reliability is low when at least one of reliabilities is low, it can be determined on safe side.

If it is configured that either one of the reliability determined by the variation degree of time series data of the curvature and the reliability determined by the variation degree of time series data of the curvature change rate is determined, the determined one reliability may be set as the comprehensive reliability as it is.

### <Determination by Frequency>

Similarly to Embodiment 1, the reliability determination unit finally determines that the reliability of the detection lane marking information is low, when a frequency at which it was determined that the reliability of the detection lane marking information is low based on the variation degree of time series data of one or both of the curvature and the curvature change rate is greater than or equal to a determination value of frequency; and finally determines that the reliability of the detection lane marking information is high, when the frequency at which it was determined that the reliability of the detection lane marking information is low based on the variation degree of time series data of one or both of the curvature and the curvature change rate is less than the determination value of frequency.

### 3. Embodiment 3

Next, the traveling lane recognition apparatus 10 and the traveling lane recognition method according to Embodiment 3 will be explained. The explanation for constituent parts the same as those in each of Embodiments 1 and 2 will be omitted. The basic configuration of the traveling lane recognition apparatus 10 and the traveling lane recognition method according to the present embodiment is the same as that of Embodiment 1 or 2. Embodiment 3 is different from Embodiment 1 or 2 in a part of processing of the reliability determination unit 13 and the driving lane marking calculation unit 14.

Similarly to Embodiment 1, the reliability determination unit 13 determines the reliability of the detection lane marking information, based on the variation of detection lane marking information. The reliability determination unit 13 determines that the reliability of the detection lane marking information is low, when an absolute value of time variation amount of the detection lane marking information or a variation degree of time series data of the detection lane marking information is greater than or equal to a determination value; and determines that the reliability of the detection lane marking information is high, when the absolute value of time variation amount of the detection lane marking information or the variation degree of time series data of the detection lane marking information is less than the determination value.

### <Determination of Reliability of Map Lane Marking Information>

In the present embodiment, the reliability determination unit 13 determines a reliability of the map lane marking information, based on the detection lane marking information and the map lane marking information.

In the present embodiment, when it is determined that the reliability of the detection lane marking information is high, the reliability determination unit 13 determines the reliability of the map lane marking information, based on a comparison result between the map lane marking information and the detection lane marking information. About each of the right and left lane markings of the traveling lane of the own vehicle, the reliability of the map lane marking information is determined based on the reliability of the detection lane marking information, the map lane marking information, and the detection lane marking information.

According to this configuration, when it is determined that the reliability of the detection lane marking information is high, the reliability of the map lane marking information can be determined with good accuracy by comparing the map lane marking information with the detection lane marking information which is determined that the reliability is high.

When it is determined that the reliability of the detection lane marking information is low, the reliability determination unit 13 holds the determination result of the reliability of the map lane marking information which was determined lastly when it was determined that the reliability of the detection lane marking information is high, and uses it.

In the present embodiment, the reliability determination unit 13 determines that the reliability of the map lane marking information is low, when an absolute value of difference between the map lane marking information and the detection lane marking information is greater than or equal to a determination value of difference; and determines that the reliability of the map lane marking information is high, when the absolute value of difference is less than the determination value of difference.

For example, the reliability determination unit 13 determines that the reliability of the map lane marking information is low, when an absolute value of difference between the curvature of the map lane marking information and the curvature of the detection lane marking information is greater than or equal to the determination value of difference; and determines that the reliability of the map lane marking information is high, when the absolute value of difference of curvatures is less than the determination value of difference.

Similarly to the detection lane marking acquisition unit 11 explained in Embodiment 1, the map lane marking acquisition unit 12 may convert the map lane marking information acquired in the past into map lane marking information on the basis of the current position of the own vehicle (referred to as past map lane marking information after conversion), based on traveling information of the own vehicle. The reliability determination unit 13 may perform an averaging processing or a filter processing to the curvature of the map lane marking information acquired this time, and a plurality of the past curvatures of the map lane marking information after conversion. As the averaging processing or the filter processing, a processing similar to the processing to the curvature of the detection lane marking information explained in Embodiment 1 is used. Then, the reliability determination unit 13 may use an average value or a filter value of the curvature of the map lane marking information as the curvature of the map lane marking information used for difference calculation; and may use an average value or a filter value of the curvature of the detection lane marking information explained in Embodiment 1 as the curvature of the detection lane marking information used for difference calculation.

Using an absolute value of difference between the curvature change rate of the map lane marking information and the curvature change rate of the detection lane marking information, the reliability of map lane marking information may be determined similarly. Similarly to determination of the reliability of the detection lane marking information, the reliability of map lane marking information may be finally determined, based on one or both of the determination result by curvature, and the determination result by the curvature change rate.

Similarly to determination of the reliability of the detection lane marking information, the reliability determination unit 13 may finally determine that the reliability of the map lane marking information is low, when a frequency at which it was determined that the reliability of the map lane marking information is low based on a comparison result of curvatures or curvature change rates is greater than or equal to a determination value of frequency; and may finally determine that the reliability of the map lane marking information is high, when the frequency at which it was determined that the reliability of the map lane marking information is low is less than the determination value of frequency.

### <Selection of Lane Marking Information for Autonomous Driving>

In the present embodiment, the driving lane marking calculation unit 14 selects the lane marking information used for autonomous driving from the detection lane marking information and the map lane marking information, based on the reliability of the detection lane marking information and the reliability of the map lane marking information, and calculates lane marking information for autonomous driving, based on the selected lane marking information. The calculation of the lane marking information for autonomous driving is performed about each of the right and left lane markings of the traveling lane of the own vehicle.

According to this configuration, since the lane marking information used for autonomous driving is selected from the detection lane marking information and the map lane marking information, based on the reliability of the map lane marking information in addition to the reliability of the detection lane marking information, selection accuracy of the lane marking information can be improved.

The driving lane marking calculation unit 14 selects the curvature K2det of the detection lane marking information, when it is determined that the reliability of the detection lane marking information is high, or when it is determined that both of the reliability of the detection lane marking information and the reliability of the map lane marking information is low; selects the curvature K2map of the map lane marking information, when it is determined that the reliability of the detection lane marking information is low and it is determined that the reliability of the map lane marking information is high; and calculates the lane marking information for autonomous driving using at least the selected curvature.

According to this configuration, even when it is determined that the reliability of the detection lane marking information is low, when it is determined that the reliability of the map lane marking information is low, the curvature K2map of the map lane marking information which has a high possibility of deviating from the actual curvature due to insufficient accuracy or non-update of map data is not selected, but the curvature K2det of the detection lane marking information is selected; and using the actually detected curvature even though its reliability is low, the lane marking information for autonomous driving close to the actual lane marking can be calculated.

And, the driving lane marking calculation unit 14 selects the curvature change rate K3det of the detection lane marking information, when it is determined that the reliability of the detection lane marking information is high, or when it is determined that both of the reliability of the detection lane marking information and the reliability of the map lane marking information is low; selects the curvature change rate K3map of the map lane marking information, when it is determined that the reliability of the detection lane marking information is low and it is determined that the reliability of the map lane marking information is high; and calculates the lane marking information for autonomous driving, using at least the selected curvature change rate.

Similarly to Embodiment 1, the driving lane marking calculation unit 14 uses selected the curvature change rate K3det of the detection lane marking information or the curvature change rate K3map of the map lane marking information, selected the curvature K2det of the detection lane marking information or the curvature K2map of the map lane marking information, the lane marking angle K1det of the detection lane marking information, and the lane marking distance K0det of the detection lane marking information, for the lane marking information for autonomous driving.

### <Flowchart>

The processing of the driving lane marking calculation unit 14 can be configured like the flowchart shown in FIG. 8. In the step S21, the driving lane marking calculation unit 14 determines whether or not it is determined that the reliability of the detection lane marking information is high. And, when the reliability is high, it advances to the step S22, and when the reliability is low, it advances to the step S23. In the step S22, the driving lane marking calculation unit 14 sets the curvature change rate K3det of the detection lane marking information, the curvature K2det of the detection lane marking information, the lane marking angle K1det of the detection lane marking information, and the lane marking distance K0det of the detection lane marking information, as the lane marking information for autonomous driving.

On the other hand, in the step S23, the driving lane marking calculation unit 14 determines whether or not it is determined that the reliability of the map lane marking information is high. And, when the reliability is high, it advances to the step S24, and when the reliability is low, it advances to the step S22. In the step S24, the driving lane marking calculation unit 14 sets the curvature change rate K3map of the map lane marking information, the curvature K2map of the map lane marking information, the lane marking angle K1det of the detection lane marking information, and the lane marking distance K0det of the detection lane marking information, as the lane marking information for autonomous driving.

### 4. Embodiment 4

Next, the traveling lane recognition apparatus 10 and the traveling lane recognition method according to Embodiment 4 will be explained. The explanation for constituent parts the same as those in each of Embodiments 1, 2, 3 will be omitted. The basic configuration of the traveling lane recognition apparatus 10 and the traveling lane recognition method according to the present embodiment is the same as that of Embodiment 1, 2, or 3. Embodiment 4 is different from Embodiment 1, 2, or 3 in a part of processing of the reliability determination unit 13.

Similarly to Embodiment 1, 2, or 3, the reliability determination unit 13 determines the reliability of the detection lane marking information, based on the variation of detection lane marking information.

In the present embodiment, the reliability determination unit 13 acquires the road information where the own vehicle is traveling, from the map data 16; determines whether or not the own vehicle is traveling a traveling lane where a detection accuracy of the lane marking by the periphery monitoring apparatus 31 decreases, based on the acquired road information; and determines that the reliability of the detection lane marking information is low, when it is determined that the own vehicle is traveling the traveling lane where the detection accuracy decreases.

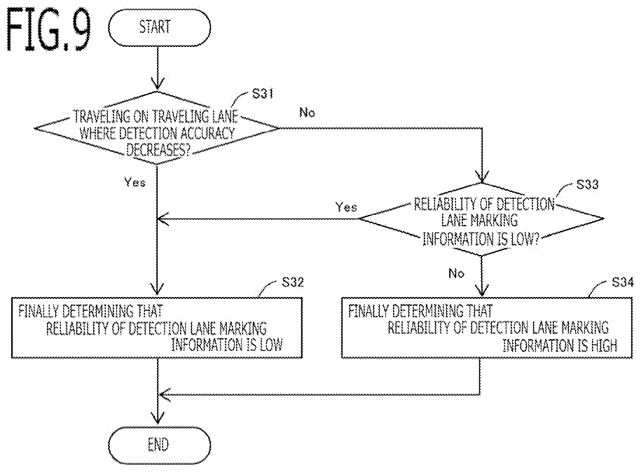

The processing of the reliability determination unit 13 can be configured like the flowchart shown in FIG. 9. In the step S31, as described above, the reliability determination unit 13 determines whether or not the own vehicle is traveling the traveling lane where the detection accuracy decreases, based on the road information acquired from the map data 16. And, when it is determined that it is traveling the traveling lane where the detection accuracy decreases, it advances to the step S32, and when it is determined that it is not traveling the traveling lane where the detection accuracy decreases, it advances to the step S33. In the step S32, the reliability determination unit 13 finally determines that the reliability of the detection lane marking information is low.

On the other hand, in the step S33, similarly to Embodiment 1 or 2, the reliability determination unit 13 determines whether or not the reliability of the detection lane marking information is low, based on the variation of the detection lane marking information. And, when it is determined that the reliability is low, it advances to the step S32, and when it is determined that the reliability is high, it advances to the step S34. In the step S34, the reliability determination unit 13 finally determines that the reliability of the detection lane marking information is high.

In this way, when it is previously turned out by road information of the map data that the own vehicle is traveling the traveling lane where the detection accuracy of the lane marking decreases, it is determined that the reliability of the detection lane marking information is low, and the determination accuracy can be improved.

For example, the type of lane marking of the traveling lane is included in the acquired road information. The reliability determination unit 13 determines whether or not the lane marking of the traveling lane is the double white lines, based on the acquired road information; and determines that the reliability of the detection lane marking information is low, when it is the double white lines.

When the lightness of road in front of the own vehicle changes suddenly, the detection accuracy of the lane marking by the front monitoring camera and the like decreases. For example, in the vicinity of the entrance and the vicinity of the exit of the tunnel, the lightness of road changes suddenly and the detection accuracy of the lane marking decreases. Other than the tunnel, a road with a structure which blocks sunlight above the road, such as a bridge and a building, corresponds; and this kind of road section where the lightness of road decreases is referred to as a lightness decrease road section. Accordingly, the reliability determination unit 13 determines whether or not there is an entrance or an exit of the lightness decrease road section, such as the tunnel, in a determination distance range in front of the own vehicle, based on the acquired road information; and determines that the reliability of the detection lane marking information is low, when there is the entrance or the exit.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

What is claimed is:

1. A traveling lane recognition apparatus comprising at least one processor configured to implement:
a detection lane marking acquisitor that acquires detection lane marking information which is information on position and shape of a lane marking of a traveling lane of an own vehicle on a basis of a position of the own vehicle, based on detection information of a periphery monitoring apparatus which monitors a periphery of the own vehicle;
a map lane marking acquisitor that acquires road information where the own vehicle is traveling, from map data, and acquires map lane marking information which is information on position and shape of the lane marking of the traveling lane of the own vehicle on the basis of the position of the own vehicle, based on the acquired road information;
a reliability determiner that determines a reliability of the detection lane marking information, based on variation of the detection lane marking information; and
a driving lane marking calculator that selects lane marking information used for autonomous driving from the detection lane marking information and the map lane marking information, based on the reliability of the detection lane marking information, and calculates lane marking information for autonomous driving, based on the selected lane marking information.

2. The traveling lane recognition apparatus according to claim 1,
wherein the detection lane marking acquisitor acquires at least a curvature of lane marking, as the detection lane marking information,
wherein the map lane marking acquisitor acquires at least a curvature of lane marking, as the map lane marking information, and
wherein the driving lane marking calculator selects the curvature of the detection lane marking information, when it is determined that the reliability of the detection lane marking information is high;
selects the curvature of the map lane marking information, when it is determined that the reliability of the detection lane marking information is low; and
calculates the lane marking information for autonomous driving using at least selected curvature.

3. The traveling lane recognition apparatus according to claim 1,
wherein the reliability determiner determines that the reliability of the detection lane marking information is low, when an absolute value of time variation amount of the detection lane marking information or a variation degree of time series data of the detection lane marking information is greater than or equal to a determination value of time variation amount or variation degree; and
determines that the reliability of the detection lane marking information is high, when the absolute value of time variation amount or the variation degree is less than the determination value of time variation amount or variation degree.

4. The traveling lane recognition apparatus according to claim 3,
wherein the reliability determiner finally determines that the reliability of the detection lane marking information is low, when a frequency at which it was determined that the reliability of the detection lane marking information is low based on the absolute value of time variation amount or the variation degree is greater than or equal to a determination value of frequency; and
finally determines that the reliability of the detection lane marking information is high, when the frequency at which it was determined that the reliability of the detection lane marking information is low based on the absolute value of time variation amount or the variation degree is less than the determination value of frequency.

5. The traveling lane recognition apparatus according to claim 4,
wherein the reliability determiner makes the determination value of frequency in the case where it is currently determined that the reliability of the detection lane marking information is low lower than the determination value of frequency in the case where it is currently determined that the reliability of the detection lane marking information is high.

6. The traveling lane recognition apparatus according to claim 3,
wherein the detection lane marking acquisitor acquires at least a curvature of lane marking, as the detection lane marking information, and
wherein the reliability determiner uses an absolute value of time variation amount of the curvature of the detection lane marking information, as the absolute value of time variation amount of the detection lane marking information, or uses a variation degree of time series data of the curvature of the detection lane marking information, as the variation degree of the time series data of the detection lane marking information.

7. The traveling lane recognition apparatus according to claim 3,
wherein the detection lane marking acquisitor acquires at least a curvature change rate of lane marking, as the detection lane marking information, and
wherein the reliability determiner uses an absolute value of time variation amount of the curvature change rate of the detection lane marking information, as the absolute value of time variation amount of the detection lane marking information, or uses a variation degree of time series data of the curvature change rate of the detection lane marking information, as the variation degree of the time series data of the detection lane marking information.

8. The traveling lane recognition apparatus according to claim 1,
wherein the detection lane marking acquisitor converts the detection lane marking information acquired in the past into detection lane marking information on the basis of the current position of the own vehicle, based on the traveling information of the own vehicle, and
wherein the reliability determiner calculates an absolute value of time variation amount of the detection lane marking information, or a variation degree of time series data of the detection lane marking information, based on the current detection lane marking information and the converted past detection lane marking information.

9. The traveling lane recognition apparatus according to claim 1,
wherein the reliability determiner determines a reliability of the map lane marking information, based on the detection lane marking information and the map lane marking information, and
wherein the driving lane marking calculator selects the lane marking information used for autonomous driving from the detection lane marking information and the map lane marking information, based on the reliability of the detection lane marking information and the reliability of the map lane marking information, and calculates the lane marking information for autonomous driving, based on the selected lane marking information.

10. The traveling lane recognition apparatus according to claim 9,
wherein, when it is determined that the reliability of the detection lane marking information is high, the reliability determiner determines the reliability of the map lane marking information, based on a comparison result between the map lane marking information and the detection lane marking information.

11. The traveling lane recognition apparatus according to claim 9,
wherein the detection lane marking acquisitor acquires at least a curvature of lane marking, as the detection lane marking information,
wherein the map lane marking acquisitor acquires at least a curvature of lane marking, as the map lane marking information, and
wherein the driving lane marking calculator selects the curvature of the detection lane marking information, when it is determined that the reliability of the detection lane marking information is high or determined that both of the reliability of the detection lane marking information and the reliability of the map lane marking information are low;
selects the curvature of the map lane marking information, when it is determined that the reliability of the detection lane marking information is low and determined that the reliability of the map lane marking information is high; and
calculates the lane marking information for autonomous driving using at least selected curvature.

12. The traveling lane recognition apparatus according to claim 1,
wherein the reliability determiner acquires the road information where the own vehicle is traveling, from the map data; determines whether or not the own vehicle is traveling a traveling lane where a detection accuracy of the lane marking by the periphery monitoring apparatus decreases, based on the acquired road information; and determines that the reliability of the detection lane marking information is low, when it is determined that the own vehicle is traveling the traveling lane where the detection accuracy decreases.

13. The traveling lane recognition apparatus according to claim 12,
wherein, when determining that the lane marking of the traveling lane of the own vehicle is double white lines which are two white lines which adjoin and become parallel with each other, or when determining that there is an entrance or an exit of a road section where a lightness of road decreases within a determination distance range in front of the own vehicle, based on the acquired road information, the reliability determiner determines that the own vehicle is traveling the traveling lane where the detection accuracy decreases.

14. The traveling lane recognition apparatus according to claim 1, further comprising an autonomous driving controller that controls a steering angle of wheels, based on the lane marking information for autonomous driving.

15. A traveling lane recognition method comprising:
acquiring detection lane marking information which is information on position and shape of a lane marking of a traveling lane of an own vehicle on a basis of a position of the own vehicle, based on detection information of a periphery monitoring apparatus which monitors a periphery of the own vehicle;
acquiring road information where the own vehicle is traveling, from map data, and acquiring map lane marking information which is information on position and shape of the lane marking of the traveling lane of the own vehicle on the basis of the position of the own vehicle, based on the acquired road information;
determining a reliability of the detection lane marking information, based on variation of the detection lane marking information; and
selecting lane marking information used for autonomous driving from the detection lane marking information and the map lane marking information, based on the reliability of the detection lane marking information, and calculating lane marking information for autonomous driving, based on the selected lane marking information.
